(19) United States
(12) Patent Application Publication
(10) Pub. No.: US 2024/0276983 A1
(43) Pub. Date: Aug. 22, 2024

(54) APPLICATION OF HIGHER ALIPHATIC ALCOHOL IN INHIBITING SENESCENCE AND INCREASING SHELF LIFE OF SOLANACEAE PLANTS

(71) Applicant: ZHUHAI RUNNONG SCIENCE AND TECHNOLOGY CO. LTD, Zhuhai (CN)

(72) Inventors: Dianxian Cai, Zhuhai (CN); Yunhao Sun, Zhuhai (CN); Xiaoming Peng, Zhuhai (CN); Guohui Yu, Zhuhai (CN); Di Qin, Zhuhai (CN)

(21) Appl. No.: 18/651,707

(22) Filed: May 1, 2024

Related U.S. Application Data
(63) Continuation of application No. PCT/CN2021/128771, filed on Nov. 4, 2021.

(51) Int. Cl. A01N 31/02; A01N 25/04; A01P 19/00

(52) U.S. Cl. CPC A01N 31/02; A01N 25/04; A01P 19/00

(57) ABSTRACT

A water emulsion containing a higher aliphatic alcohol of the present disclosure can affect contents of signal substances lysophosphatidylcholine and lysophosphatidylethanolamine in Solanaceae plants, and transcriptional levels of genes related to phenylpropanoid metabolism pathway by an external application, thereby inhibiting senescence and increasing shelf life of the Solanaceae plants. In addition, a use of improving a resistance to pests and diseases of the Solanaceae plants can be achieved by increasing a content of lignin.

### CROSS-REFERENCE TO RELATED APPLICATIONS

The present application is a Continuation Application of PCT Application No. PCT/CN2021/128771, filed on Nov. 4, 2021, the entire contents of which are hereby incorporated by reference.

### TECHNICAL FIELD

The present disclosure relates to an application of higher aliphatic alcohol in inhibiting senescence and increasing shelf life of Solanaceae plants.

### DESCRIPTION OF THE PRIOR ART

Solanaceae plants cover many important vegetables, economic crops and ornamental plants. Solanaceae plants such as tomato, eggplant and pepper, are important vegetables and economic crops in China, a planting of Solanaceae plants plays an important role in ensuring a stable supply of vegetable baskets and promoting the revitalization and development of rural areas, and the planting of tobacco is also an important agricultural economic pillar in many places. In a process of production, the Solanaceae plants are faced with slow growth, leaf yellowing and the like caused by insufficient fertilizer and water, unbalanced nutrition, high temperature, water stress, light and other adversity; or an improper use of hormones and drugs, causing a premature senescence of crops, and thereby leading to a serious decline in yield and quality.

### SUMMARY OF THE DISCLOSURE

In order to overcome shortcomings of prior art, a purpose of the present disclosure is to provide a use of higher aliphatic alcohol in inhibiting senescence and increasing shelf life of Solanaceae plants.

In order to solve the above problems, the present disclosure provides the following technical solution.

The present disclosure provides a use of a higher aliphatic alcohol in preparing a preparation for increasing contents of lysophosphatidylcholine and lysophosphatidylethanolamine in Solanaceae plants, and a use of inhibiting a senescence of the Solanaceae plants is achieved by increasing the contents of lysophosphatidylcholine and lysophosphatidylethanolamine in the Solanaceae plants through the higher aliphatic alcohol.

On the other hand, the present disclosure provides a use of a higher aliphatic alcohol in preparing a preparation for increasing contents of lysophosphatidylcholine and lysophosphatidylethanolamine in Solanaceae plants, and a use of increasing a shelf life of the Solanaceae plants is achieved by increasing the contents of lysophosphatidylcholine and lysophosphatidylethanolamine in the Solanaceae plants through the higher aliphatic alcohol.

On the other hand, the present disclosure provides a use of a higher aliphatic alcohol in preparing a preparation for increasing transcriptional levels of genes related to a phenylpropanoid metabolism pathway in Solanaceae plants, and a use of increasing a content of lignin is achieved by increasing transcriptional levels of genes related to the phenylpropanoid metabolism pathway in the Solanaceae plants through the higher aliphatic alcohol.

In one embodiment, a use of improving a resistance to diseases of the Solanaceae plants is achieved by increasing the content of the lignin through the higher aliphatic alcohol.

In the present disclosure, the higher aliphatic alcohol is one of dodecanol and cetyl alcohol or a mixture of dodecanol and cetyl alcohol.

In one embodiment, the preparation is a water emulsion, and the water emulsion includes the higher aliphatic alcohol, an emulsifier, a thickener and water.

The preparation containing the higher aliphatic alcohol of the present disclosure is not limited to the water emulsion, all dosage forms as long as adopt an inventive concept of the present disclosure, are applicable, for example, wettable powder, emulsion, sprayable solution, concentrated emulsion, aerosol and seed coating agent.

Compared with the prior art, beneficial effects of the present disclosure are as follows.

The water emulsion containing the higher aliphatic alcohol of the present disclosure can affect the content of signal substances lysophosphatidylcholine and lysophosphatidylethanolamine in the Solanaceae plants, and the transcriptional levels of genes related to phenylpropanoid metabolism pathway by an external application, thereby inhibiting senescence and increasing shelf life of Solanaceae plants. In addition, the use of improving a resistance to pests and diseases of the Solanaceae plants can be achieved by increasing the content of lignin.

### DESCRIPTION OF EMBODIMENTS

### Example 1

A water emulsion containing a higher aliphatic alcohol is provided in the example, and the water emulsion consists of the following components in a weight percentage: 24% dodecanol, 3% cetyl alcohol, 3% emulsifier, 5% thickener, and the rest is water.

In the example, the emulsifier is aliphatic acid polyoxyethylene ester, and the thickener is methyl cellulose.

A method of preparing the water emulsion is also provided in the example, including the following steps:
Putting the dodecanol and the cetyl alcohol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 2

A water emulsion containing a higher aliphatic alcohol is provided in the example, and the water emulsion consists of the following components in a weight percentage: 24% dodecanol, 3% emulsifier, 5% thickener, and the rest is water.

In the example, the emulsifier is aliphatic acid polyoxyethylene ester, and the thickener is methyl cellulose.

A method of preparing the water emulsion is also provided in the example, including the following steps:

Putting the dodecanol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 3

A water emulsion containing a higher aliphatic alcohol is provided in the example, and the water emulsion consists of the following components in a weight percentage: 3% cetyl alcohol, 3% emulsifier, 5% thickener, and the rest is water.

In the example, the emulsifier is aliphatic acid polyoxyethylene ester, and the thickener is methyl cellulose.

A method of preparing the water emulsion is also provided in the example, including the following steps:
Putting the cetyl alcohol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 4

A water emulsion is provided in the example, and the water emulsion consists of the following components in a weight percentage: 3% emulsifier, 5% thickener, and the rest is water.

In the example, the emulsifier is aliphatic acid polyoxyethylene ester, and the thickener is methyl cellulose.

Putting the emulsifier to a container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 5: An Effect of the Water Emulsion Containing the Higher Aliphatic Alcohol on Contents of Lysophosphatidylcholine and Lysophosphatidylethanolamine in Tomatoes

Lysophosphatidylcholine and lysophosphatidylethanolamine are important signal substances in plant cells, a normal physiological source is formed after phospholipids are hydrolyzed by phospholipase to remove a long carbon chain, which can be induced by various pressures. A premature senescence of plants can be inhibited, and an activity of phenylalanine ammonia-lyase, a key enzyme related to immunity and resistance to abiotic stress can be activated by Lysophosphatidylethanolamine. Tomato samples are treated with the water emulsion containing the higher aliphatic alcohol of the present disclosure, a metabolite determination and a transcriptome sequencing are performed, and the effect of the water emulsion of the present disclosure on the content of lysophosphatidylcholine and lysophosphatidylethanolamine in tomato is analyzed.

### (1) Aliphatic Alcohol Sample: The Water Emulsion Made by the Present Disclosure Listed in Table 1.

TABLE 1
sample numbers

| | sample numbers | | | | |
|---|---|---|---|---|---|
| | sample | sample | sample | sample | sample |
| | S-component | A-component | B-component | C-component | CK(comparison) |
| raw | Example 1 | Example 2 | Example 3 | Example 4 | clean water |
| materials | | | | | |

### (2) Test Plants: Tomatoes (Money Maker).

Culture conditions: 70/0 μmol m⁻² s⁻¹ (light/dark cycle light intensity), 14 hours/10 hours (time of light/dark cycle), 27° C./24° C., 70% relative humidity, four weeks old.

### (3) Sample Processing and Data Collection.

Healthy plants with similar growth status in a group are selected, and leaves are sprayed using dilutions of the above samples (900 times diluted with water), until the leaves are completely covered with a liquid film. The comparison group is sprayed with a same amount of sterile water for diluting a stock solution. A second spraying treatment is performed after 48 hours. Three biological replicates are provided in each group.

72 hours after a first treatment, 4 grams of leaf samples are collected from each group. The leaf samples are quickly frozen in liquid nitrogen for 3 minutes, kept warm with dry ice and sent to a laboratory of Wuhan Metware Biotechnology Inc. for metabolomics sequencing (all metabolome and transcriptome sequencing data below are provided by Wuhan Metware Biotechnology Inc.).

### (4) An Effect of a Treatment on the Contents of the Two Signal Substances.

After tomato leaves are treated with a mixed preparation of dodecanol and cetyl alcohol (S), the dodecanol separate preparation (A), the emulsifier (C) and CK (clean water) for 72 hours, detection results of the signal substances lysophosphatidylcholine (12:0 (12 carbons without double bonds)) and lysophosphatidylethanolamine (16:3 (16 carbons with three double bonds)) in physiological metabolites are shown in Table 2. The detection results show that compared with tissues treated by the clean water comparison and the emulsifier (C), the contents of lysophosphatidylcholine and lysophosphatidylethanolamine in the tissues treated with the mixed sample (S) and the dodecanol separate preparation (A) are increased significantly. The contents of the signal substances in the tissues treated with the emulsifier are substantially the same with the contents of the signal substances in the tissues treated with clean water, and there is no significant difference. It is indicated that an increase of the signal substances is caused by the treatment with the higher fatty alcohol, rather than by the emulsifier.

From content change results of the two signal substances caused by a separate treatment and a mixed treatment of the higher aliphatic alcohol, it can be seen that the content of the above two signal substances can be up-regulated by both the separate treatment and the mixed treatment of the higher aliphatic alcohol.

TABLE 2
a content ratio of lysophosphatidylcholine and lysophosphatidylethanolamine
in the tomato leaves plants in each treatment group (increase multiple)

| | tomato | tomato | tomato | tomato |
|---|---|---|---|---|
| | Lysophospha- | lysophospha- | lysophospha- | lysophospha- |
| | tidylcholine | tidylcholine | tidylethanolamine | tidylethanolamine |
| | 12:0 | 14:0 | 14:0(2n isomer) | 14:0 |
| S/comparison | 42.8 | 4.22 | 5.02 | 4.96 |
| S/C | 38.94 | 4.03 | 5.04 | 4.33 |
| A/comparison | 22.48 | 2.3 | 3.07 | 3.07 |
| A/C | 20.4 | 2.2 | 3.63 | 2.68 |
| C/comparison | 1.1 | 1.05 | 0.85 | 1.14 |

Labeling of types of lysophospholipids: 12:0 means 12 carbons with no double bonds, 14:0 means 14 carbons with no double bonds, 14:0 (2n isomer) means an isomer of 14 carbons with no double bonds.

### Example 6: An Effect of the Water Emulsion Containing the Higher Aliphatic Alcohol on Transcriptional Levels of Genes Related to a Phenylpropanoid Metabolism Pathway in the Tomato

Lysophospholipids are involved in a regulation of phenylalanine ammonia lyase activity, which is a specific metabolic pathway for the signal substances, and is also one of the most important plant secondary metabolic pathways, thereby playing an important role in plant disease resistance and fruit quality. A content of lysophospholipid signal substance in tomato leaves can be significantly up-regulated by higher aliphatic alcohol preparations of the present disclosure, showing that downstream metabolic pathways may be further affected. Therefore, the transcriptional levels of genes related to phenylpropanoid metabolic pathway are further detected in the tomato leaves treated with sample (S) and the tomato leaves treated with clean water. Phenylpropanoid metabolism is one of the most important plant secondary metabolic pathways, playing an important role in the plant growth and development and plant-environment interactions. The pathway includes a plurality of branch pathways, producing metabolites such as lignin, flavonoids and the like. Lignin is mainly accumulated in secondary cell walls and participates in a process of providing mechanical support, water transport, resistance to pests and diseases, and resistance to non-physiological stress. The metabolites such as isoflavones in flavonoids assist plant cells in reducing ultraviolet damage, removing reactive oxygen species, resisting an occurrence of diseases, and tolerating uncomfortable temperatures and high-salt drought conditions and other physiological processes.
(1) Aliphatic alcohol sample: the same as Example 5.
(2) Test plants: the same as Example 5.
(3) Sample processing and data collection: the same as Example 5, and a transcriptome sequencing is completed by Wuhan Metware Biotechnology Inc.
(4) Treating the effect on the transcriptional levels of genes related to the phenylpropanoid metabolic pathway.

Effects of different treatments on the transcriptional levels of genes related to the phenylpropanoid metabolism pathway in the tomato leaves are shown in Table 3. A result of a transcriptome determination shows that the transcriptional levels of some genes related to phenylpropanoid metabolism pathway in plant tissues can be significantly up-regulated by treated with the mixed preparation (S).

TABLE 3
a difference ratio of the transcriptional levels of genes related
to phenylpropanoid metabolism pathway in the tomato leaves plants .

| | tomato |
|---|---|
| names of gene encoding protein | S/comparison |
| scopoletin glucosyltransferase | 2.57 |
| shikimate O-hydroxycinnamoyltransferase | 60.8 |
| caffeoyl-CoA O-methyltransferase | 5.91 |
| cinnamoyl-CoA reductase | 8.29 |
| cinnamyl-alcohol dehydrogenase | 2.65 |
| Peroxidase | 84.27 |
| phenylalanine ammonia-lyase | 45.53 |
| chalcone synthase | 2.45 |
| flavonoid 3′-monooxygenase | 2.05 |
| isoflavone 3′-hydroxylase | 2.78 |

### Example 7: Effects of Using the Water Emulsion Containing the Higher Aliphatic Alcohol on the Tobacco Leaves

Sampling: Sample (S) is the water emulsion containing the higher aliphatic alcohol prepared by Example 1.

Crop: yellow tobacco.

Location: Mashi Town, Shixing County, Shaoguan City, Guangdong Province.

Method: Selecting a 31.4-mu test group and a 32.8-mu comparison group at a production base to produce according to Table 4, mu is an area unit, and 1 mu equals 0.067 hectares.

TABLE 4
a test scheme of the water emulsion containing the higher aliphatic
alcohol of the present disclosure in the tobacco leaves

| serial | | | |
|---|---|---|---|
| number | processing period | test group | comparison group |
| 1 | After the seedlings are | The sample (S) is diluted | At the same time as the |
| | established, spray once | 900 times with water and | test group is treated, the |
| | every 15 days for a | then sprayed. sample | same amount of clean |
| | total of 3 times. | dosage: 50 mL/mu, time | water is sprayed. |

A comparison of the use effects.

During a whole growth process, the yellow tobacco of the test group treated with the water emulsion containing the higher aliphatic alcohol of the present disclosure has no obvious disease damage; an appearance of the yellow tobacco of the test group exhibits obvious advantages in growth vigour and growth feature; and the yellow tobacco of the test group has a tall plant type, deep roots, lush leaves, as well as dark and shiny leaves. A damage caused by black shank and bacterial wilt is found during a growth process of the yellow tobacco of the comparison group, and an appearance is obviously weaker in growth vigour and growth feature.

During the whole growth process of the yellow tobacco, severe weather conditions such as low temperature in an early stage, high temperature and high humidity in middle and late stages occur. The test group grows normally at all stages and shows obvious enhanced resistance to stress, for example, abilities to resist local low temperatures during a seedling stage, resist rain and scorching heat during a growth period, and resist various diseases before and after yellowing are significantly enhanced. However, a response of the comparison group to an external environment is obvious and is easily affected by the external environment.

During the whole growth process of the yellow tobacco, compared with the comparison group, the yellowing (ripening and senescence) of the tobacco leaves in the test group treated with the water emulsion containing the higher aliphatic alcohol of the present disclosure is delayed for six days, the tobacco plants are taller and the tobacco leaves are thicker, wider and longer.

A detection result after harvest is as follows:

TABLE 5
a detection result of the yellow tobacco treated with the water emulsion
containing the higher aliphatic alcohol of the present disclosure

| serial | | test | comparison |
|---|---|---|---|
| number | item | group | group |
| 1 | planting area (mu) | 31.4 | 32.8 |
| 2 | total weight (kg) | 5233.15 | 4484.3 |
| 3 | superior tobacco leaves (kg) | 3675.65 | 3405.8 |
| 4 | middle tobacco leaves (kg) | 1557.5 | 1078.5 |
| 5 | yield per mu(kg) | 166.66 | 136.72 |

The tobacco leaves of the test group treated with the water emulsion containing the higher aliphatic alcohol of the present disclosure have fewer diseases and are less affected by the environment. Plant heights, deep roots and lush leaves, superior tobaccos and medium tobaccos of the test group are significantly better than those of the comparison group, and the yield of the tobacco leaves is increased by 21.9%. In addition, the senescence of the yellow tobacco plants of the test group is slower than the senescence of the yellow tobacco plants of the comparison group.

### Example 8: An Use Effect of the Water Emulsion Containing the Higher Aliphatic Alcohol in a Field Production of Cherry Tomatoes

Sampling: sample (S) is the water emulsion containing the higher aliphatic alcohol prepared by Example 1.

Crop: cherry tomatoes.

Location: Shangyang Town, Yangxi County, Yangjiang City, Guangdong Province.

Method: selecting a 40-mu test group and a 40-mu comparison group in a production base to produce according to Table 6.

TABLE 6
a test scheme of the water emulsion containing the higher aliphatic
alcohol of the present disclosure in cherry tomatoes

| serial | processing | | |
|---|---|---|---|
| number | period | test group | comparison group |
| 1 | seedling stage | The sample (S) is diluted 900 times | At the same time as the |
| | | with water and sprayed once. | test group is treated, the |
| | | sample dosage: 30 mL/mu, time | same amount of clean |
| | | | water is sprayed |
| 2 | initial | The sample (S) is diluted 900 times | At the same time as the |
| | flowering | with water and sprayed once. | test group is treated, the |
| | stage | sample dosage: 30 mL/mu, time | same amount of clean |
| | | | water is sprayed |
| 3 | after fruit | The sample (S) is diluted 900 times | At the same time as the |
| | setting | with water and sprayed once. | test group is treated, the |
| | | sample dosage: 30 mL/mu, time | same amount of clean |
| | | | water is sprayed |

A comparison of the use effects.

During a whole growth process, the cherry tomatoes of the test group treated with the water emulsion containing the higher aliphatic alcohol of the present disclosure have no obvious disease damage; and the cherry tomatoes of the test group have a tall plant type, deep roots, lush leaves, as well as dark and shiny leaves, and an appearance of the cherry tomatoes of the test group exhibits obvious advantages. In the comparison group, bacterial wilt and powdery mildew are found during a growth process, and an appearance in growth vigour and growth feature are significantly weaker.

During the growth of cherry tomatoes, cold wind and low temperature weather occur during the seedling stage, the seedlings of the test group have no frostbite and grow normally. However, the seedlings of the comparison group have obvious frostbite.

When the harvest in the comparison group is completed and the garden is cleared, the cherry tomato plants in the test group are still vigorous, opening a batch of flowers and bearing a batch of fruits more than the comparison group.

A test result is as follows:

TABLE 7
the test result of the cherry tomatoes treated with the water emulsion
containing the higher aliphatic alcohol of the present disclosure

| serial | | | |
|---|---|---|---|
| number | item | test group | comparison group |
| 1 | effect of low temperature | No seedling frostbite is | The seedling frostbite is |
| | | found, and the seedlings | obvious |
| | | grow normally | |
| 2 | disease | No obvious pests and | Bacterial wilt and powdery |
| | | diseases are found, | mildew are found, |
| | | abnormal strain 0.1% | accounting for 5% of a total |
| | | | number of plants |
| 3 | cracked fruit | 0.3% | 9% |
| 4 | appearance | The fruit size is uniform | The fruit size is uneven and |
| | | and the peel is smooth | the peel color is dim |
| | | and bright | |
| 5 | yield per mu (kg) | 4110 | 3480 |

The cherry tomatoes of the test group treated with the water emulsion containing the higher aliphatic alcohol of the present disclosure have less disease, cold resistance, deep roots and lush leaves, uniform fruit size, smooth and bright peel. The appearance is obviously better than the appearance of the comparison group, and the yield increase rate reaches 18.1%. When the harvest in the comparison group is completed and the garden is cleared, the plants in the test group are still vigorous and can bloom and bear fruit.

### Example 9: Use Effects of the Water Emulsion Containing the Higher Aliphatic Alcohol in the Field Production of Pod Peppers

Sampling: sample (S) is the water emulsion containing the higher aliphatic alcohol prepared by Example 1.

Crop: pod peppers.

Location: Xiaqiao Town, Xuwen County, Zhanjiang City, Guangdong Province.

Method: selecting a 10-mu test group and a 10-mu comparison group in a production base to produce according to Table 8.

TABLE 8
a test scheme of the water emulsion containing the higher
aliphatic alcohol of the present disclosure in pod peppers

| serial | processing | | |
|---|---|---|---|
| number | period | test group | comparison group |
| 1 | seedling | the sample (S) is diluted 900 times | at the same time as the |
| | stage | with water and sprayed once | test group is treated, the |
| | | sample dosage: 20 mL/mu, time | same amount of clean |
| | | | water is sprayed |
| 2 | initial | the sample (S) is diluted 900 times | at the same time as the |
| | flowering | with water and sprayed once | test group is treated, the |
| | stage | sample dosage: 20 mL/mu, time | same amount of clean |
| | | | water is sprayed |
| 3 | after fruit | the sample (S) is diluted 900 times | at the same time as the |
| | setting | with water and sprayed once | test group is treated, the |
| | | sample dosage: 20 mL/mu, time | same amount of clean |
| | | | water is sprayed |

A comparison of the use effects.

During a whole growth process, the pod peppers of the test group treated with the water emulsion containing the higher aliphatic alcohol of the present disclosure have no obvious disease damage; and the pod peppers of the test group have a tall plant type, and dark and shiny leaves. In the comparison group, downy mildew and damping-off diseases are found during a growth process, a plant height is lower than a plant height of the test group, and a color of leaves is lighter.

In a fruiting period, the pod peppers of the test group have more branches, more flowers, uniform fruit shape and bright color, and an average weight of each picking is 12.1% more than that of the comparison group. The pod peppers are picked every 15 days, the comparison group is picked 6 times, the plants become senescent and cannot flower and bear fruit normally after picking 6 times. At this time, stems and leaves of the plants of the test group grow normally, and a quantity of picking times is 2 times more than that of the comparison group, and a total of 8 times are picked, the yield is increased by 49.47% in the whole growth process.

It can be seen from Examples 5 that using the water emulsion containing the higher aliphatic alcohol diluted with water to treat Solanaceae plants (tomatoes), the content of signal substances lysophosphatidylcholine (12:0 (12 carbons without double bonds), 14:0 (14 carbons without double bonds)) and lysophosphatidylethanolamine (14:0 (2n isomer) (14 carbons without double bonds), 14:0 (14 carbons without double bonds)) can be increases, the transcription levels of anabolism-related genes in the phenylpropanoid pathway and contents of corresponding substances are significantly affected; thereby slowing down plant senescence, improving quality and increasing yield of the Solanaceae plants. The field application results of Examples 7, 8 and 9 show that through using the water emulsion containing the higher aliphatic alcohol of the present disclosure, the Solanaceae plants exhibit reduced disease occurrences, robust growth, delayed senescence, enhanced product quality, and increased yield.

It can be seen from Example 5 to Example 9 that, by applying the water emulsion containing the higher aliphatic alcohol of the present disclosure to the Solanaceae plants, the contents of signal substances lysophosphatidylcholine (12:0, 14:0) and lysophosphatidylethanolamine (14:0 (2n isomer), 14:0) in plant physiological metabolism can be increased, the transcription levels of anabolism-related genes in the phenylpropanoid pathway and contents of corresponding substances are significantly affected; the premature senescence of crops and a decline in yield and quality caused by insufficient fertilizer and water, unbalanced nutrition, high temperature, water stress, light and other adversities during a crop growth are improved, thereby effectively slowing down the plant senescence of Solanaceae plants, extending the picking time, improving the quality and increasing the yield in an actual agricultural production.

The above are merely some embodiments of the present disclosure, cannot be construed to limit the present disclosure. Any changes, modifications, alternatives and variations can be made in the embodiments without departing from the scope of the present disclosure, but these all fall into the protection scope of the present disclosure.

1. Use of a higher aliphatic alcohol in preparing a preparation for increasing contents of lysophosphatidylcholine and lysophosphatidylethanolamine in Solanaceae plants, wherein, a use of inhibiting a senescence of the Solanaceae plants is achieved by increasing the contents of lysophosphatidylcholine and lysophosphatidylethanolamine in the Solanaceae plants through the higher aliphatic alcohol.

2. The use of claim 1, wherein the higher aliphatic alcohol is one of dodecanol and cetyl alcohol or a mixture of dodecanol and cetyl alcohol.

3. The use of claim 1, wherein the preparation is a water emulsion, and the water emulsion comprises the higher aliphatic alcohol, an emulsifier, a thickener and water.

4. Use of a higher aliphatic alcohol in preparing a preparation for increasing contents of lysophosphatidylcholine and lysophosphatidylethanolamine in Solanaceae plants, wherein, a use of increasing a shelf life of the Solanaceae plants is achieved by increasing the contents of lysophosphatidylcholine and lysophosphatidylethanolamine in the Solanaceae plants through the higher aliphatic alcohol.

5. The use of claim 4, wherein the higher aliphatic alcohol is one of dodecanol and cetyl alcohol or a mixture of dodecanol and cetyl alcohol.

6. The use of claim 4, wherein the preparation is a water emulsion, and the water emulsion comprises the higher aliphatic alcohol, an emulsifier, a thickener and water.

7. Use of a higher aliphatic alcohol in preparing a preparation for increasing transcriptional levels of genes related to a phenylpropanoid metabolism pathway in Solanaceae plants, wherein a use of increasing a content of lignin is achieved by increasing transcriptional levels of genes related to the phenylpropanoid metabolism pathway in the Solanaceae plants through the higher aliphatic alcohol.

8. The use of claim 7, wherein a use of improving a resistance to diseases of the Solanaceae plants is achieved by increasing the content of the lignin through the higher aliphatic alcohol.

9. The use of claim 7, wherein the higher aliphatic alcohol is one of dodecanol and cetyl alcohol or a mixture of dodecanol and cetyl alcohol.

10. The use of claim 7, wherein the preparation is a water emulsion, and the water emulsion comprises the higher aliphatic alcohol, an emulsifier, a thickener and water.
